(19) United States
(12) Patent Application Publication
(10) Pub. No.: US 2014/0108867 A1
(43) Pub. Date: Apr. 17, 2014

(54) Dynamic Taint Analysis of Multi-Threaded Programs

(71) Applicant: NEC Laboratories America, Inc., Princeton, NJ (US)

(72) Inventors: Malay Ganai, Plainsboro, NJ (US); Dongyoon Lee, Ann Arbor, MI (US); Aarti Gupta, Princeton, NJ (US)

(73) Assignee: NEC LABORATORIES AMERICA, INC., Princeton, NJ (US)

(21) Appl. No.: 13/800,060

(22) Filed: Mar. 13, 2013

Related U.S. Application Data
(60) Provisional application No. 61/610,822, filed on Mar. 14, 2012.

(51) Int. Cl. G06F 11/14

(52) U.S. Cl. CPC G06F 11/1482
USPC 714/38.1

(57) ABSTRACT

Disclosed is a dynamic taint analysis framework for multithreaded programs (DTAM) that identifies a subset of program inputs and shared memory accesses that are relevant for issues related to concurrency. Computer implemented methods according to the framework generally involve the computer implemented steps of: applying independently a dynamic taint analysis to each of the multiple threads comprising a multi-threaded computer program; aggregating each independent result from the analysis for each of the multiple threads by consolidating effect of taint analysis in one or more possible re-orderings of observed shared memory accesses among threads; and outputting an indicia of the aggregated result as a set of relevant program inputs or a set of relevant shared memory accesses.

### CROSS REFERENCE TO RELATED APPLICATIONS

This application claims the benefit of U.S. Provisional Application Ser. No. 61/610,822 filed Mar. 14, 2012.

### TECHNICAL FIELD

This disclosure relates generally to the field of computer software and in particular to a method for testing and debugging multi-threaded computer programs.

### BACKGROUND

Testing and debugging multi-threaded programs is notoriously difficult due—in part—to at least two sources of inherent non-determinism namely, inputs (i.e., user and/or system data) and OS schedules (i.e., order of shared accesses). Incapable of systematically exploring the non-determinism, techniques for testing and debugging multi-threaded programs selectively record global events corresponding to the sources of non-determinism as determined by underlying requirements. Such recording may include all inputs and shared accesses for deterministic replay of failures, and all/sampled shared access for runtime detection/prediction. While this recording does help reduce the overall search space, it comes with a cost - namely reduced coverage and performance penalties.

### SUMMARY

An advance in the art is made according to an aspect of the present disclosure directed to a dynamic taint analysis framework for multithreaded programs (DTAM) that identifies a subset of inputs and shared memories that are relevant for issues related to concurrency.

According to an aspect of the present disclosure, a method of performing dynamic taint analysis of a multi-threaded computer program is disclosed. The method comprises the computer implemented steps of: applying independently a dynamic taint analysis to each of the multiple threads comprising the multi-threaded computer program; aggregating each independent result from the analysis for each of the multiple threads; and outputting an indicia of the aggregated result as a list of relevant inputs or relevant shared accesses.

### BRIEF DESCRIPTION OF THE DRAWING

A more complete understanding of the present disclosure may be realized by reference to the accompanying drawing in which:

FIG. 1 is a pair of diagrams depicting: 1(a) Input Relevancy and 1(b) Shared Memory Relevancy according to an aspect of the present disclosure;

FIG. 2 depicts a generic architecture for practicing Dynamic Taint Analysis for multi-threaded programs according to aspects of the present disclosure;

FIG. 3 depicts a schematic block diagram of an overall DTAM method according to an aspect of the present disclosure.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

By way of some additional background, we begin by noting that previous work on dynamic taint analysis does not consider multi-threaded programs. (See, for example, J. A. Clause, W. Li, A. Orso; DYTAN: A Generic Dymanic Taint Analysis Framework; ISSTA 2007; pp. 196-206) More particularly, such works focus on reducing performance overhead of taint propagation and runtime checks for sequential programs with better instrumentation techniques.

Additional techniques directed to whole-system emulation such as PANORAMA (See, e.g., H. Yin, D. Song, M. Egele, C. Krugel, and E. Krida; “PANORAMA: Capturing System-Wide Information Flow for Malware Detection and Analysis; ACM Conference on Computer and Communications Security 2007; pp. 116-127)

Methods of relevancy analysis such as PENUMBRA (See, e.g., J. Clause; A. Orso; PENUMBRA: Automatically identifying failure-relevant inputs using dynamic tainting; ISSTA 2009: 249-260), wherein dynamic taint analysis for sequential programs is used to identify relevant input that causes an observed failure in a sequential program. As noted, it is not applicable to multi-threaded programs.

In LiteRace (See, e.g., D. Marino, M. Musuvathi, and S. Narayanasamy, LiteRace: Effective Sampling for Lightweight Data-Race detection; PLDI, pp. 134-143, 2009), the authors therein proposed to reduce the performance performance overhead of dynamic data-race detection using a sampling based approach to process/record a small percentage of memory based on infrequent visits, thereby avoiding every memory operation executed by the program. And while the approach reduces logging overhead, the approach is ad-hoc and does not use any taint analysis.

Finally, replay based systems (See, e.g., S. Park, Y. Zhou, W. Xiong, Z. Yin, R. Kaushik, K. Lee and S. Lu; PRES: Probabilistic Replay With Execution Sketching on Multiprocessors; SOSP 2009, pp. 177-190; and G. Altekar and I. Stoica; ODR: Output-Deterministic Replay for Multicore Debugging SOSP 2009, pp. 193-206).

With this background in place, a more complete discussion of a method and techniques according to the present disclosure is provided in the Appendix A to this Description. Briefly, our method focuses on two main sources of non-determinism in multi-threaded program executions namely, inputs and shared accesses (i.e., accesses to shared objects). Operationally, we identify a subset of input sources and shared objects that are—in a sense—relevant for covering program behavior. We classify different types of relevancy in terms of how an input source or a shared object can affect control flow (e.g., a conditional branch) or dataflow (e.g., state of the shared objects) in the program. Our relevancy analysis can then be used by testing and debugging techniques to reduce their recording overhead and further guide coverage.

As previously noted, we disclose herein a framework based on dynamic taint analysis for multi-threaded programs, we call DTAM. It performs thread-modular taint analysis for each thread in parallel during runtime, and then aggregates the thread-modular results offline. As will become apparent, our approach offers a number of advantages namely, (a) it is faster than conducting taint analysis for serialized multi-threaded executions, (b) it computes results for alternate thread interleavings by generalizing the observed execution and (c) it provides a mechanism to trade-off precision with coverage, depending upon how thread-modular results are aggregated to account for alternate interleavings.

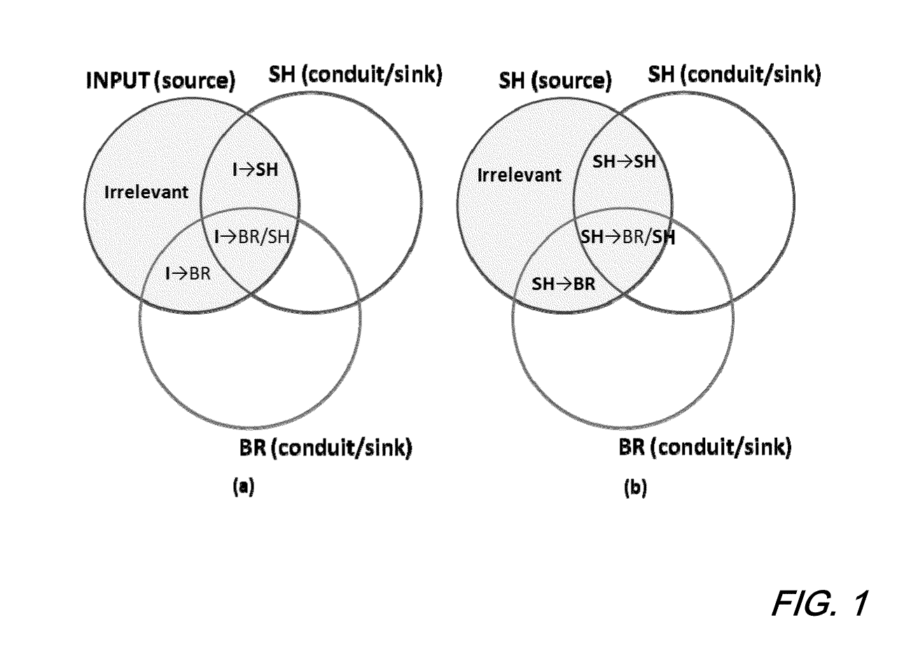

In order to assess relevance, a method according to the present disclosure will classify inputs and shared memories as depicted in FIGS. 1(a) and 1(b). Inputs of particular interest (relevant inputs) are those which may affect program behaviors (output, final coredump, etc.) by changing shared-object state or control-flow state of a multi-threaded program.

With reference to that FIG. 1(a) depicting Input Relevancy, we assign the types of inputs based on their influence on branches (BR), and shared accesses (SH). A branch/shared access is either a “conduit” (i.e., helps propagate the effect on an input), or a “sink” (i.e., it is affected by an input) or both. The inputs that do not affect any shared access and do not affect any branch are referred to as irrelevant inputs.

For our purposes, we are interested in knowing whether an input can affect a shared access (sink) without any branch support (I→SH), a branch (sink) but not any shared access (I→BR), or both a shared access and a branch in some execution (I→BR/SH) where a branch/shared memory is a conduit/sink. Similarly, with reference to FIG. 1(b), depicting shared memory relevancy, we determine the relevancy of a shared memory.

Our dynamic taint analysis generally operates as follows. During runtime, it tags suspicious data—normally from an external input—propagates taint tag along data and control flow, and then checks if tagged data is used for potentially problematic locations (e.g., used for a target location of a jump instruction).

Operationally, our method tags all program inputs using unique IDs, including return values of system calls and data copied from kernel to user space (e.g., data read by a sys_read( )). Our runtime system propagates the tag along both data and control flow dependencies, then checks the tag on shared accesses (which are identified either by profiling or static analysis) and conditional branches. When the taint tag is propagated to shared accesses, we say that the corresponding input can affect the shared-memory state of the program, and is therefore relevant. Similarly, the input which can have an effect on a conditional branch is treated as relevant input as well. A similar analysis is performed for taints associated with shared memories.

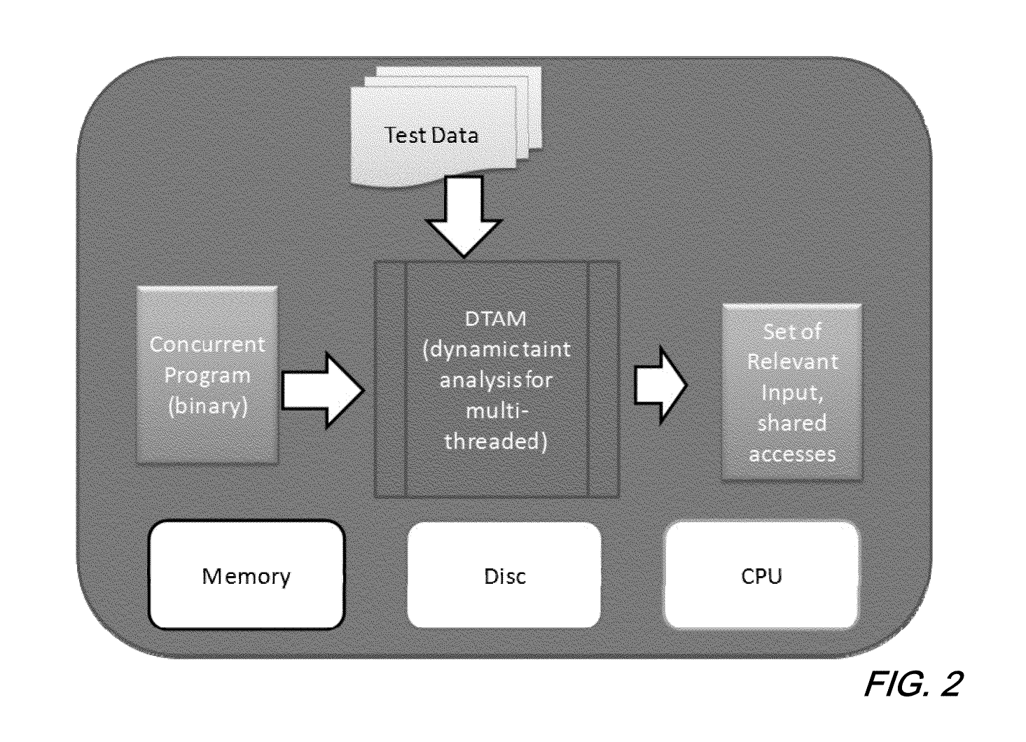

Turning now to FIG. 2, there is shown a schematic block diagram of an architecture for practicing dynamic taint analysis for multi-threaded programs according to an aspect of the present disclosure. More particularly, a concurrent program and test data undergo DTAM such that a set of relevant inputs and/or shared accesses are produced.

Advantageously, at least three different approaches to DTAM according to the present disclosure are contemplated, a) DTAM-serial (online/offline); b) DTAM-parallel; and c) DTAM-hybrid.

According to aspects of the disclosure, with DTAM-serial (online), the multi-threaded execution is first serialized (i.e., the trace becomes sequential) and DTA is then applied. Such an approach oftentimes leads to under-tainting and increased runtime(s) due to the serialization. DTAM-serial(offline), DTAM-parallel and DTAM-hybrid take advantage of parallelism by employing thread-modular taint analysis. DTAM-parallel/hybrid further offers more generalized results and while DTAM-parallel may A

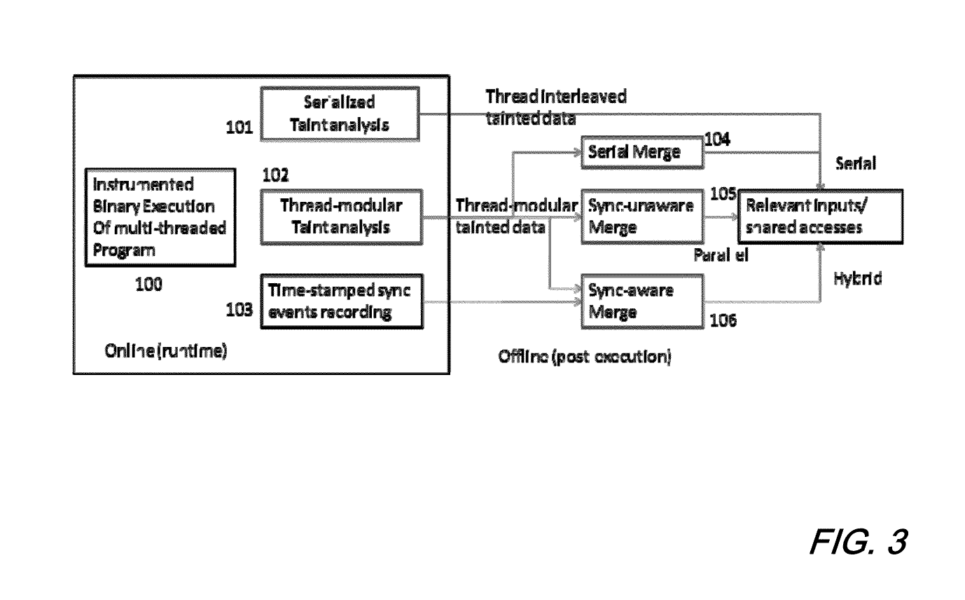

FIG. 3 shows an overview of the overall DTAM process and approaches according to the present disclosure. As depicted in FIG. 3, an instrumented program 100 is executed and dynamic taint analysis is performed. Advantageously, serialized 101 or thread-modular 102 taint analysis may be performed. With the DTAM-serialized method, atomicity must be preserved between original instructions and instrumented code.

Thread modular taint analysis may be performed by logging intermediate taint data during shared accesses 102. Synchronization events and shared accesses are recorded with vector time stamps 103 and for thread modular taint analysis, the thread modular tainted data is merged in a serialized manner 104, sync-unaware 105, or sync-aware 106 manners to obtain relevant input and shared memories.

According to aspects of the present disclosure DTAM-parallel comprises two separate stages. In the first stage, each thread performs taint analysis locally, and possibly in parallel with other threads at runtime. In the second stage, thread-modular results are merged (possibly offline). To enable thread-modular taint analysis, the system treats a shared read access as another type of input, and generates a pseudo taint tag for subsequent propagation. Moreover, when a thread executes a shared write access, the system logs its address and taint tag, if any. This is done so that during the later merging stage a taint tag can be propagated from this point to other threads. The merge collects the result of each thread and aggregates the results for multithreaded execution. In this manner, it replaces the pseudo taint tags on shared reads with the taint tags on shared writes from remote threads, as if the tag has propagated across threads.

DTAM-hybrid works similar to DTAM-parallel, but also considers must-happen-before relationships between synchronization operations. In this approach, a taint tag is propagated from a shared write in one thread to a shared read in another thread only if there is no must-happen-before order enforced by synchronizations that prevent read-after-write dependencies. Advantageously, by considering synchronization operations, DTAM-hybrid enables the collection of more generalized results (on other multi-threaded traces) than DTAM-serial while avoiding over-tainting as sometimes experienced with DTAM-parallel.

Finally, DTAM-serial (offline), while similar to DTAM-parallel, allows the propagation of a taint tag only from the last shared write to the shared read corresponding to the introduced tag at the shared read.

At this point, the foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. As previously noted, additional information is provided in Appendix A to this Description. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method of performing dynamic taint analysis of a multi-threaded computer program communicating with shared memory where some of the shared memory accesses are used for thread synchronization and some of the shared memory accesses are used for data exchange between threads, said method comprising the computer implemented steps of:
applying independently a dynamic taint analysis to each of the multiple threads comprising the multi-threaded computer program, wherein taint propagates from tainted inputs to a set of outputs in local thread order through thread-local and shared memory accesses in each thread, independent of the other threads;
aggregating each independent result comprising tainted outputs and the propagated tainted inputs from the said analysis for each of the multiple threads, wherein aggregation consolidates the effect of taint propagation in one or more possible re-orderings of observed shared memory accesses; and
outputting an indicia of the aggregated result as a set of outputs tainted with the propagated tainted inputs.

2. The method of claim 1 wherein the aggregation step considers the observed total order of memory accesses.

3. The method of claim 1 wherein the aggregation step considers all orderings of shared memory accesses that follow observed local-thread ordering.

4. The method of claim 3 wherein the aggregation step considers all orderings of shared memory accesses that follow the observed synchronization and local-thread ordering.

5. The method of claim 1 wherein the aggregated result when used for a relevancy analysis comprises a set of relevant program inputs or a set of relevant shared memory accesses such that one or more of the set affects one or more program conditional branches or shared memory accesses through taint propagation.

6. A method of analyzing of a multi-threaded computer program comprising the computer implemented steps of:
serializing the execution of the multi-threaded program during its execution;
applying dynamic taint analysis to the serialized multi-threaded program execution; and
outputting an indicia of the aggregated result as a list of relevant inputs or relevant shared memory accesses such that one or more of the set affects one or more program conditional branches or shared memory accesses through taint propagation.

7. A system for performing dynamic taint analysis of a multi-threaded computer program communicating with shared memory where some of the shared memory accesses are used for thread synchronization and some of the shared memory accesses are used for data exchange between threads, said system comprising a computing device including a processor and a memory coupled to said processor said memory having stored thereon computer executable instructions that upon execution by the processor cause the system to:
apply independently a dynamic taint analysis to each of the multiple threads comprising the multi-threaded computer program, wherein taint propagates from tainted inputs to a set of outputs in local thread order through thread-local and shared memory accesses in each thread, independent of the other threads;
aggregate each independent result comprising tainted outputs and the propagated tainted inputs from the said analysis for each of the multiple threads, wherein aggregation consolidates the effect of taint propagation in one or more possible re-orderings of observed shared memory accesses; and
output an indicia of the aggregated result as a set of outputs tainted with the propagated tainted inputs.

8. The system of claim 7 wherein the aggregation step considers the observed total order of memory accesses.

9. The system of claim 7 wherein the aggregation step considers all orderings of shared memory access that follow the observed local thread ordering.

10. The system of claim 8 wherein the aggregation step considers all orderings of all memory accesses that follow the observed synchronization and local thread ordering.

11. The system of claim 7 wherein the aggregate result when used for a relevancy analysis comprises a set of relevant program inputs or a set of relevant shared memory accesses such that one or more of the set affects one or more program conditional branches or shared memory accesses through taint propagation.

12. A system for analyzing a multi-threaded computer program said system including a processor and a memory coupled to said processor said memory having stored thereon computer executable instructions that upon execution by the processor cause the system to:
serialize the execution of the multi-threaded program during its execution;
apply dynamic taint analysis to the serialized multi-threaded program execution; and
output an indicia of the aggregated result as a list of relevant inputs or relevant shared memory accesses such that one or more of the set affects one or more program conditional branches or shared memory accesses through taint propagation.
